(19) United States
(12) Patent Application Publication
(10) Pub. No.: US 2003/0149588 A1
(43) Pub. Date: Aug. 7, 2003

(54) Apparatus and method for providing information for protecting, marketing, and/or commercializing, intellectual property

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 10/347,933

(22) Filed: Jan. 22, 2003

Related U.S. Application Data
(60) Provisional application No. 60/355,714, filed on Feb. 7, 2002.

(51) Int. Cl. G06F 17/60

(52) U.S. Cl. 705/1

(57) ABSTRACT

An apparatus and method for providing information for protecting and/or commercializing an invention or new idea, including a receiver for receiving a request for information regarding protecting an invention or new idea, wherein the request is received from a user communication device, a processor for processing the request, wherein the processor generates a message containing at least one of a question and an instruction for obtaining information regarding the invention or new idea, and a transmitter for transmitting the message to the user device. The receiver receives a user response to the at least one of question and an instruction, and further wherein the processor generates an invention disclosure containing information regarding the invention or new idea.

### RELATED APPLICATIONS

This application claims the benefit of priority of U.S. Provisional Patent Application Serial No. 60/355,714 filed Feb. 7, 2002, and entitled “APPARATUS AND METHOD FOR PROVIDING INFORMATION FOR PROTECTING, MARKETING, AND/OR COMMERCIALIZING, INTELLECTUAL PROPERTY”, the subject matter of which is hereby incorporated by reference herein.

### FIELD OF THE INVENTION

The present invention pertains to an apparatus and method for providing information for protecting, marketing, and/or commercializing, intellectual property and, in particular, to an apparatus and method for providing information for protecting, marketing and/or commercializing, inventions, original creations, and/or works of authorship.

### BACKGROUND OF THE INVENTION

Many individuals dream of inventing that million dollar idea, or creating that million dollar creation, as a way in which to achieve fame and fortune. These individuals are usually interested in either patenting their ideas or copyrighting their original creations, whichever the case may be. However, the legal costs or fees associated with filing and prosecuting patent applications, and to a lesser extent, the fees associated with obtaining copyrights for protecting copyrightable works, can be overwhelming to many individuals. The specialized areas of patent law and copyright law are typically unavailable to individuals of modest means.

A number of organizations have emerged which promote themselves as invention submission companies or marketing or promotion companies. These companies, however, usually provide only limited services for individuals. Many individuals who utilize these companies typically find the experience as less than gratifying.

Although many companies and publications purport to provide services or information for inventors and creators of original works, there exists no system or method which provides information to individuals which can allow these individuals to protect their ideas, to market or commercialize their ideas, and/or to be introduced to entities which can facilitate the development and/or commercialization of products and services premised upon their ideas.

### SUMMARY OF THE INVENTION

The present invention pertains to an apparatus and method for providing information for protecting, marketing, and/or commercializing, intellectual property and, in particular, to an apparatus and method for providing information for protecting, marketing and/or commercializing, inventions, original creations, and/or works of authorship.

The apparatus and method of the present invention can be utilized to provide inventors with information for preparing an invention disclosure, a provisional patent application, and a non-provisional patent application. In this manner, the present invention can be utilized in order to provide an individual with information which can be utilized to obtain at least some form of preliminary protection for an invention which can serve to allow the individual to have at least some form of intellectual property protection at the outset or commencement of the marketing, development, and/or commercialization, activities relating to or pertaining to the invention.

The apparatus and method of the present invention can also be utilized to provide information regarding commercialization strategies and/or activities, information regarding licensing and/or sale strategies and/or activities, and/or information for creating a business or business relationships for commercializing, the invention.

The apparatus and method of the present invention can be utilized to provide authors and creators of original works with information regarding obtaining copyright protection, a copyright application, and/or a copyright for heir creation or creations. In this manner, the present invention can be utilized in order to provide an individual with information which can be utilized to obtain at least some form of preliminary protection for the original work or creation which can serve to allow the individual to have at least some form of intellectual property protection at the outset or commencement of the marketing, development, and/or commercialization, activities relating to or pertaining to the original work or creation.

The apparatus and method of the present invention can also be utilized to provide information regarding commercialization strategies and/or activities, information regarding licensing and/or sale strategies and/or activities, and/or information for creating a business or business relationships for commercializing, the original work or creation.

The apparatus includes a central processing Computer and a user communication device. The apparatus can also include a service provider computer or communication device, a marketing provider computer or communication device, an investor computer or communication device, an information provider computer or communication device, and an official filing office computer.

The present invention can be utilized in order to provide information to users, inventors, authors, or creators, which can provide assistance and/or guidance for protecting or safeguarding their new ideas and/or inventions as well as information for developing, marketing, promoting, and/or commercializing their ideas, inventions and creations. The present invention can also provide information for enabling or assisting a user to obtain a provisional patent application and patent pending status for an invention, in cases involving patent protection, or can provide information for a enabling or assisting a user to obtain a copyright or copyright application pending status in cases involving copyright protection.

The present invention can also provide information for referring the user to attorneys, patent attorneys, patent agents, copyright attorneys, trademark attorneys, intellectual property attorneys, corporate attorneys, patent search firms, marketing firms, product development firms, promotion firms, and any other service providers, marketing providers, etc., who or which can provide assistance to the user.

The present invention can also provide information regarding potential investors, manufacturing companies, potential buyers of new ideas, potential licensees of new ideas, and any other individuals or entities who or which may invest in new ideas and/or who or which can develop and/or commercialize new ideas.

The present invention can also provide information regarding filing requirements and procedures for filing patent applications, provisional patent applications, patent cooperation treaty (PCT) applications, regional patent applications, design patent applications, plant patent applications, utility model applications, and/or any other form of intellectual property protection available in the United States and in foreign countries or states. The present invention can also provide information for obtaining information and/or assistance from the respective patent office(s), trademark office(s), and/or copyright office(s).

The present invention can also provide information to potential investors, buyers or purchasers, potential licensees, and potential partners and/or commercialization partners, regarding the existence of new ideas, inventions, or creations, in which they may have an interest.

The present invention of the present invention can, in short, provide information and guidance to inventors of new ideas, new inventions, and patentable inventions, so as to allow the inventor to obtain at least provisional patent protection or patent pending status, obtain patent search information, find or locate a patent attorney or patent agent to assist in preparing a non-provisional patent application and/or provide guidance to assist an inventor in preparing his or her own patent application, determine or formulate a product or service development or commercialization strategy, form partnerships or alliances with manufacturers or providers, and essentially, to provide information and assistance to an inventor in the inventor's activities and efforts in furtherance of protecting, developing, and/or commercializing his or her invention.

In the case of books, stories, novels, poems, new designs, new product designs, logos, plays, screen plays, and/or any other creations or works of authorship, which can be commercialized and/or which can be protected under intellectual property laws and/or the copyright laws of any respective country or state, the present invention can provide information for obtaining copyright protection for the new creation, design, or work of authorship, find or locate an intellectual property attorney or copyright attorney to assist in preparing his or her own copyright application, determine or formulate a product or service development or commercialization strategy, form partnerships or alliances with publishers, manufacturers or providers, and essentially, to provide information and assistance to an individual in the individual's activities and efforts in furtherance of protecting, developing, and/or commercializing his or her creation, design, or work of authorship.

In another preferred embodiment, the present invention can be utilized as an intellectual property clearinghouse for selling and/or licensing intellectual property rights in patents, copyrights, and/or trademarks (hereinafter collectively referred to as “intellectual property”). In this embodiment, the users can classify register their respective intellectual property, inventions, new ideas, creations, works of authorship, and/or trademarks, with the central processing computer.

In another preferred embodiment, the user can access the central processing computer and perform a search regarding new ideas, inventions, or creations, which may be desired to be purchased or licensed, by any of the herein-described individuals, companies, or entities. The user can thereafter attempt to develop an invention, new idea, or creation, which satisfies the need of the posting individual, company, or entity.

In another embodiment, the present invention can be utilized so as to provide a clearinghouse by which users, inventors, authors, and creators, can find or locate service providers who or which can assist them in protecting, developing, marketing, and/or commercializing their respective inventions, new ideas, and creations. In this embodiment, the respective service providers, which can be any of the service providers described herein, can register with the central processing computer and provide information regarding the services which they perform (i.e. prepare patent applications, prepare copyright applications, negotiate licenses, provide litigation services, provide corporate formation services, perform merger and/or acquisition services, perform marketing services, and/or any other services, described herein, and/or which can be related to protecting, developing, marketing, and/or commercializing, inventions, new ideas, and/or creations.

The respective service providers can post information regarding their areas of expertise, services provides, terms or conditions of service, and fees for services and/or representation or engagement.

### BRIEF DESCRIPTION OF THE DRAWINGS

In the Drawings:

FIG. 1 illustrates a preferred embodiment of the apparatus of the present invention, in block diagram form;

FIGS. 2A, 2B and 2C, illustrate a preferred embodiment method for utilizing the apparatus of FIG. 1, in flow diagram form;

FIG. 3 illustrates another preferred embodiment method for utilizing the apparatus of FIG. 1, in flow diagram form; and

FIG. 4 illustrates still another preferred embodiment method for utilizing the apparatus of FIG. 1, in flow diagram form.

### DESCRIPTION OF THE PREFERRED EMBODIMENTS

The present invention pertains to an apparatus and method for providing information for protecting, marketing, and/or commercializing, intellectual property and, in particular, to an apparatus and method for providing information for protecting, marketing and/or commercializing, inventions, original creations, and/or works of authorship.

The apparatus and method of the present invention can be utilized to provide inventors with information for preparing an invention disclosure, a provisional patent application, and a non-provisional patent application. In this manner, the present invention can be utilized in order to provide an individual with information which can be utilized to obtain at least some form of preliminary protection for an invention which can serve to allow the individual to have at least some form of intellectual property protection at the outset or commencement of the marketing, development, and/or commercialization, activities relating to or pertaining to the invention.

The apparatus and method of the present invention can also be utilized to provide information regarding commercialization strategies and/or activities, information regarding licensing and/or sale strategies and/or activities, and/or information for creating a business or business relationships for commercializing, the invention.

The apparatus and method of the present invention can be utilized to provide authors and creators of original works with information regarding obtaining copyright protection, a copyright application, and/or a copyright for heir creation or creations. In this manner, the present invention can be utilized in order to provide an individual with information which can be utilized to obtain at least some form of preliminary protection for the original work or creation which can serve to allow the individual to have at least some form of intellectual property protection at the outset or commencement of the marketing, development, and/or commercialization, activities relating to or pertaining to the original work or creation.

The apparatus and method of the present invention can also be utilized to provide information regarding commercialization strategies and/or activities, information regarding licensing and/or sale strategies and/or activities, and/or information for creating a business or business relationships for commercializing, the original work or creation.

As utilized herein, the term “user”, or the plural of same, refers to any inventor, inventors, creator, creators, author, or authors, of a respective invention or creation, who may utilize the apparatus and method of the present invention.

Applicant hereby incorporates by reference herein the subject matter and teachings of U.S. Provisional Patent Application Serial No. 60/355,714 which teaches and discloses an apparatus and method for providing information for protecting, marketing, and/or commercializing, intellectual property.

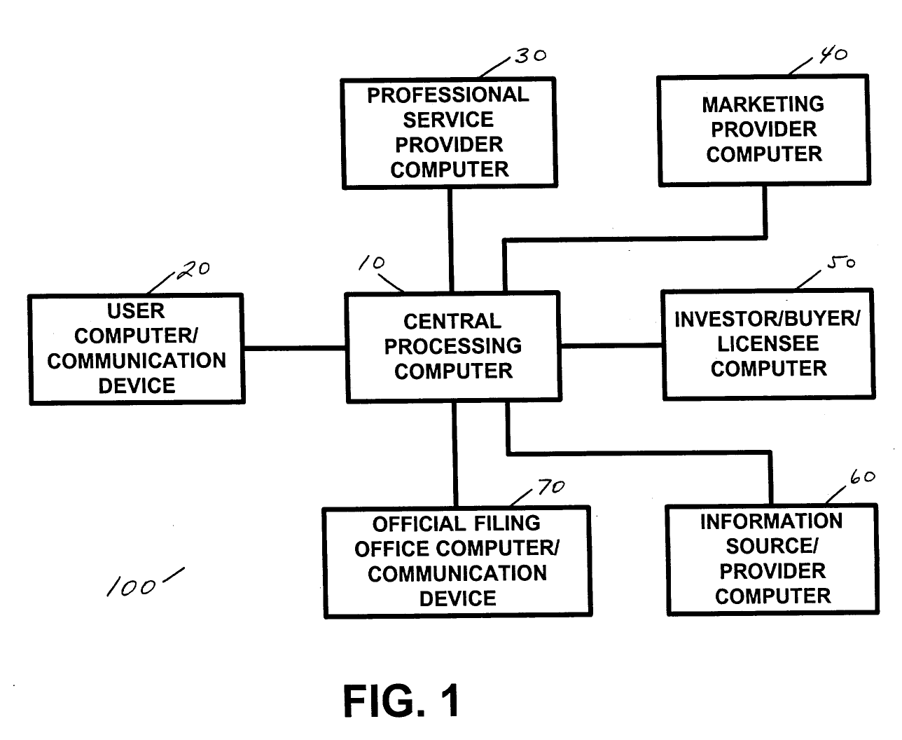

FIG. 1 illustrates a preferred embodiment of the apparatus of the present invention, which is designated generally by the reference numeral 100, in block diagram form. With reference to FIG. 1, the apparatus includes a central processing computer 10. The central processing computer 10 can perform all of the processing routines described herein as being provided by the apparatus 100 as well as by any of the other computers or communication devices described herein. In the preferred embodiment, the central processing computer 10 can be any suitable computer, server computer, or network computer.

The apparatus 100 can also include a user computer or communication device 20 (“user communication device 20”) which can be any computer or communication device which facilitates user communication with the central processing computer 10. In the preferred embodiment, the user communication device 20 can be any one or more of a computer, a personal computer, a laptop computer, a personal digital assistant, a hand-held device, a palm-top device, a telephone, a cellular telephone, a wireless telephone, a video telephone, a personal communication service device, a pager, and/or a watch.

The user communication device 20 can transmit signals to as well as receive signals from the central processing computer 10.

The apparatus 100 can also include a professional service provider computer 30 or communication device, which can be associated with a professional service provider. Professional services providers can include lawyers, patent lawyers, intellectual property lawyers, copyright lawyers, trademark lawyers, corporate lawyers, business consultants, accountants, patent agents, and/or any other professional services providers which can or may be engaged and/or utilized in protecting, marketing, and/or commercializing new ideas, inventions, or creations.

The apparatus 100 can also include a marketing provider computer 40 or communication device, which can be associated with a marketing provider who or which can provide marketing and/or promotion services for new ideas, inventions, and/or creations.

The apparatus 100 can also include an investor computer 50 or communication device, which can be associated with a respective investor, buyer, and/or licensee, of a new idea, invention, or creation, or any respective patent application, patent, copyright application, or copyright which is associated with or which corresponds to the respective new idea, invention, or creation.

The apparatus 100 can also include an information provider computer 60 or communication device, which can be associated with a respective information provider.

The apparatus 100 can also include an official filing office computer 70, which can be associated with a respective official filing office. The official filing office computer can, for example, be a computer associated with a Patent Office, a Trademark Office, or a Copyright Office, of a particular country of region of countries. For example, the official filing office computer 70 can be a computer or communication device associated with the United States Patent and Trademark Office or the Patent or Trademark Office(s) of any other country, state, or regional offices.

In the preferred embodiment, each of the central processing computer 10, the user computer 20, the professional service provider computer 30, the marketing provider computer 40, the investor computer 50, the information provider computer 60, and the official filing computer 70, can include any number of computers or computer systems.

In the preferred embodiment, each of the central processing computer 10, the user computer 20, the professional service provider computer 30, the marketing provider computer 40, the investor computer 50, the information provider computer 60, and the official filing computer 70, and can communication with any and/or all of the other central processing computers 10, the user computers 20, the professional service provider computers 30, the marketing provider computers 40, the investor computers 50, the information provider computers 60, and the official filing computers 70, described herein.

Each of the central processing computers 10, the user computers 20, the professional service provider computers 30, the marketing provider computers 40, the investor computers 50, the information provider computers 60, and the official filing computers 70, described herein, can include a central processing unit, a RAM memory device, a ROM memory device, an input device, an output device, a display device, a receiver, a transmitter, and a database(s) for storing any of the data and/or information which may be needed and/or desired for performing any of the processing routines and/or functionality described herein and/or for providing any of the information and/or services described herein as being provided by the apparatus 100 of the present invention.

In the preferred embodiment, the apparatus 100 is utilized on or over the Internet and/or the World Wide Web. In another preferred embodiment, the apparatus 100 of the present invention can be utilized on, over, and/or in conjunction with, any communication network, a telephone network, a public-switched telephone network, a satellite communication network, a broadband communication network, a digital communication network, a wireless communication network, and/or any other communication network, and/ore any combination of same.

The apparatus 100 can be utilized in order to provide information to users, inventors, authors, or creators, which can provide assistance and/or guidance for protecting or safeguarding their new ideas and/or inventions as well as information for developing, marketing, promoting, and/or commercializing their ideas, inventions and creations.

The apparatus 100 can also provide information for enabling or assisting a user to obtain a provisional patent application and patent pending status for an invention, in cases involving patent protection, or can provide information for a enabling or assisting a user to obtain a copyright or copyright application pending status in cases involving copyright protection.

The apparatus 100 can also provide information for referring the user to attorneys, patent attorneys, patent agents, copyright attorneys, trademark attorneys, intellectual property attorneys, corporate attorneys, patent search firms, marketing firms, product development firms, promotion firms, and any other service providers, marketing providers, etc., who or which can provide assistance to the user.

The apparatus 100 can also provide information regarding potential investors, manufacturing companies, potential buyers of new ideas, potential licensees of new ideas, and any other individuals or entities who or which may invest in new ideas and/or who or which can develop and/or commercialize new ideas.

The apparatus 100 can also provide information regarding filing requirements and procedures for filing patent applications, provisional patent applications, patent cooperation treaty (PCT) applications, regional patent applications, design patent applications, plant patent applications, utility model applications, and/or any other form of intellectual property protection available in the United States and in foreign countries or states. The apparatus 100 can also provide information for obtaining information and/or assistance from the respective patent office(s), trademark office(s), and/or copyright office(s).

The apparatus 100 can also provide information to potential investors, buyers or purchasers, potential licensees, and potential partners and/or commercialization partners, regarding the existence of new ideas, inventions, or creations, in which they may have an interest.

The apparatus 100 of the present invention can, in short, provide information and guidance to inventors of new ideas, new inventions, and patentable inventions, so as to allow the inventor to obtain at least provisional patent protection or patent pending status, obtain patent search information, find or locate a patent attorney or patent agent to assist in preparing a non-provisional patent application and/or provide guidance to assist an inventor in preparing his or her own patent application, determine or formulate a product or service development or commercialization strategy, form partnerships or alliances with manufacturers or providers, and essentially, to provide information and assistance to an inventor in the inventor's activities and efforts in furtherance of protecting, developing, and/or commercializing his or her invention.

In the case of books, stories, novels, poems, new designs, new product designs, logos, plays, screen plays, and/or any other creations or works of authorship, which can be commercialized and/or which can be protected under intellectual property laws and/or the copyright laws of any respective country or state, the apparatus 100 can provide information for obtaining copyright protection for the new creation, design, or work of authorship, find or locate an intellectual property attorney or copyright attorney to assist in preparing his or her own copyright application, determine or formulate a product or service development or commercialization strategy, form partnerships or alliances with publishers, manufacturers or providers, and essentially, to provide information and assistance to an individual in the individual's activities and efforts in furtherance of protecting, developing, and/or commercializing his or her creation, design, or work of authorship.

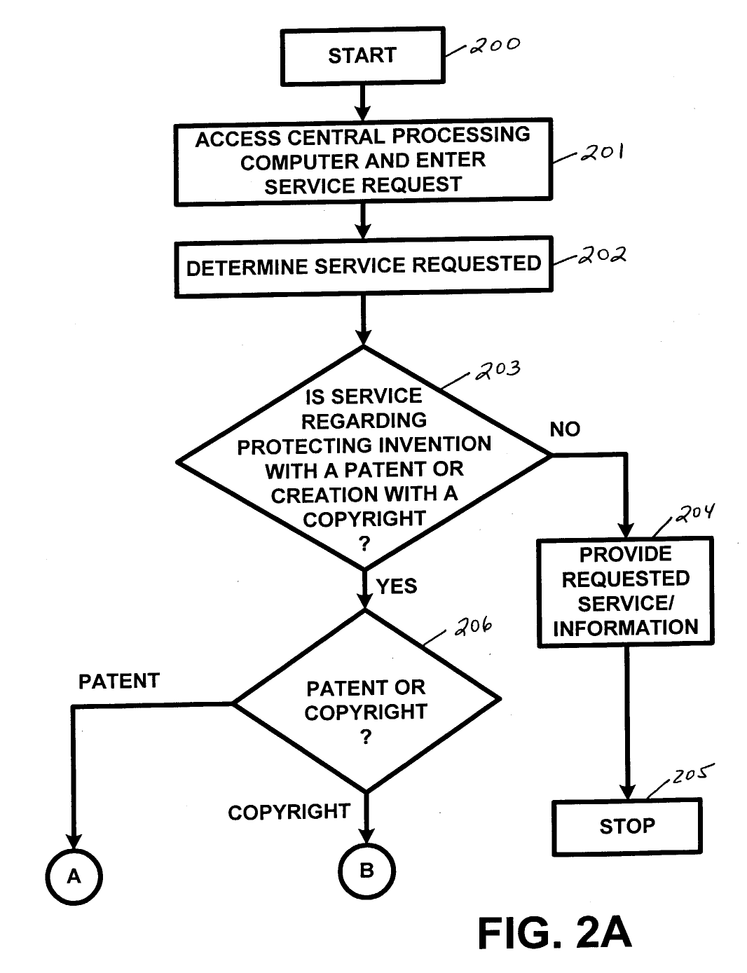

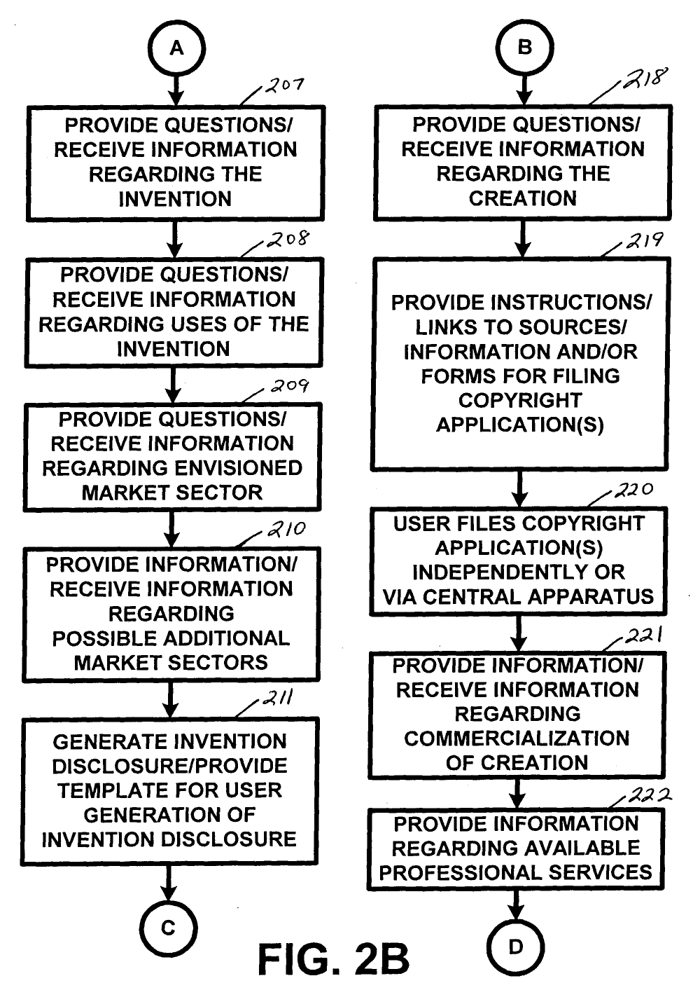

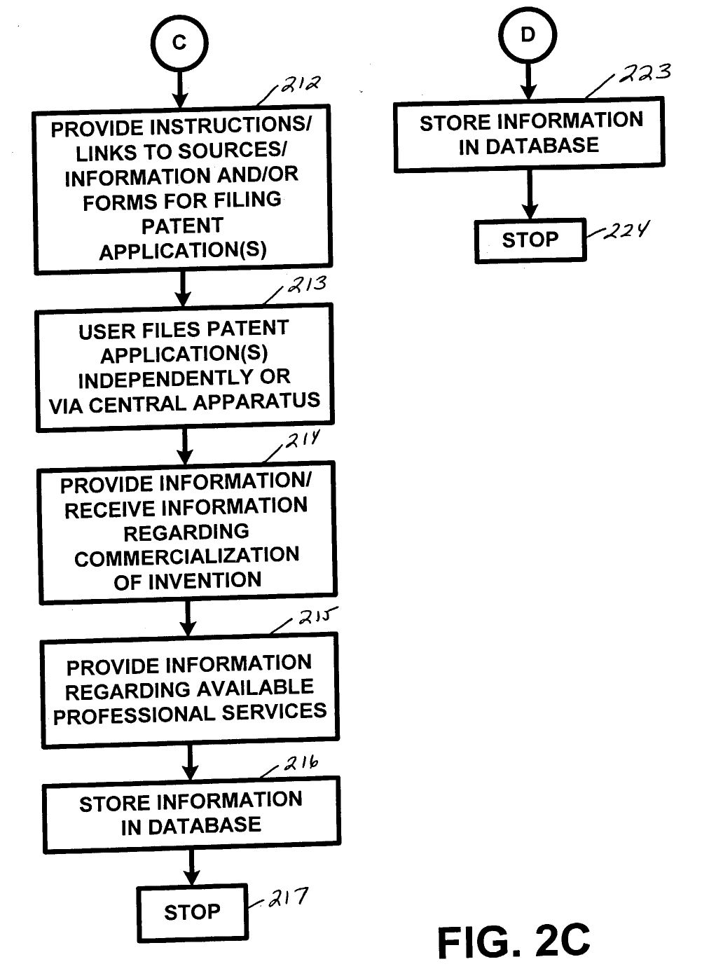

FIGS. 2A, 2B and 2C, illustrate a preferred embodiment method for utilizing the apparatus 100 of FIG. 1 in providing the aforementioned and/or the herein-described information and/or assistance to an individual or user, in flow diagram form.

With reference to FIGS. 2A, 2B and 2C, the operation of the apparatus 100 commences at step 200. At step 201, the user accesses the central processing computer 10 via the user communication device 20. At step 201, the user can enter his or her request for information pertaining to his or her situation. For example, a user with a new product idea can request information pertaining to obtaining patent protection, the patenting process, patent search information, and/or related information. A user with a book, new design, screen play, or literary work, can request information pertaining to obtaining copyright protection, the copyrighting process, search information, and/or related information. The central processing computer 10 can provide guidance to the user in the information request step by providing informative menus from which the user can select and request information pertinent to the user's situation.

At step 202, the central processing computer 10 can receive and process the user's request and determine the service or services which are requested and/or which are pertinent to the user's needs and/or situation. At step 203, the central processing computer 10 can determine whether the requested or needed service involves protecting an invention with a patent or protecting a creation with a copyright.

If, at step 203, it is determined that the requested or needed service does not involve protecting an invention with a patent or protecting a creation with a copyright, the central processing computer 10 will proceed to step 204 and provide the requested service and/or information to the user communication device 20. The user can then obtain the information from the user communication device 20.

The information and/or service provided at step 204 can, for example, be information regarding protecting trade secrets, obtaining a copyright, and/or referring the user to a lawyer, business consultant, and/or any other suitable service provider or information source. Thereafter, the operation of the apparatus 100 will cease at step 205.

If, at step 203, it is determined that the requested or needed service involves protecting an invention with a patent or protecting a creation with a copyright, the central processing computer 10 will proceed to step 206 and determine whether the request involves an invention which may involve patent protection or a creation which may involve copyright protection. If, at step 206, it is determined that the request involves an invention which may involve patent protection, the operation of the central processing computer 10 will proceed to step 207.

At step 207, the central processing computer 10 can provide questions to the user via the user communication device 20 will serve to illicit information from the user regarding the user's invention or new idea. The questions can be designed to obtain information from the user which can facilitate the preparation of an invention disclosure. Some examples of questions can be as follows:

“What is your new idea or invention?”

“Is it a product, device, computer program, process, or method?”

“What problem does it solve?”

“What are advantages and benefits over the known products, devices, processes, or services?”

“How is the invention different from prior art products, devices, processes, or services?”

“What is the invention or new idea comprised of?”

“What are the needed and/or desired component parts of the invention or new product, and/or whet are the needed and/or desired steps of the process or method, and what, if any equivalents or substitutes can be utilized or substituted for same?”

“How is the new invention, new product, process or method, utilized?”

It is important to note that the above questions are only examples and can be in any form or format and can include any other questions or types of questions and/or statements or instructions which can be designed in any appropriate manner in order to assist a user to provide thorough and complete information regarding his or her invention or new idea, sufficient enough to prepare an invention disclosure.

At step 207, the user can answer these questions on-line and the central processing computer 10 can receive and process the user's response in a manner so that the responses can be utilized in preparing or generating an invention disclosure.

At step 208, the central processing computer 10 can provide questions to the user regarding the uses of the invention or new idea. These question are designed to obtain information regarding uses for the invention or new idea and can also be utilized in preparing or generating an invention disclosure. Some example questions are as follows:

“What are the uses for the invention or new product?”

“Can the invention or product be utilized in other applications or areas of use?”

It is important to note that the above questions are only examples and can be in any form or format and can include any other questions or types of questions and/or statements or instructions which can be designed in any appropriate manner in order to assist a user to provide thorough and complete information regarding his or her invention or new idea, sufficient enough to prepare an invention disclosure.

At step 208, the user can answer these questions on-line and the central processing computer 10 can receive and process the user's response in a manner so that the responses can be utilized in preparing or generating an invention disclosure.

At step 209, the central processing computer 10 can provide questions to the user regarding the envisioned market sector for the invention or new idea. These question are designed to obtain information regarding the envisioned market sector for the invention or new idea and can also be utilized in preparing or generating an invention disclosure. Some example questions are as follows:

“What is the envisioned market sector, (i.e. automotive, hand tools, women's products, e-commerce, etc.)?”

“Who are the envisioned or anticipated customers (i.e. men, women, boys, girls, computer information technology companies, manufacturing equipment users, etc.)?”

It is important to note that the above questions are only examples and can be in any form or format and can include any other questions or types of questions and/or statements or instructions which can be designed in any appropriate manner in order to assist a user to provide thorough and complete information regarding his or her invention or new idea, sufficient enough to prepare an invention disclosure.

At step 209, the user can answer these questions on-line and the central processing computer 10 can receive and process the user's response in a manner so that the responses can be utilized in preparing or generating an invention disclosure.

At step 210, the central processing computer 10 can provide questions regarding any additional uses or market sectors for which the invention or new idea can be adapted. Some example questions are:

“Are there any other uses for the invention or new idea not before contemplated (i.e. can a vehicle security system be adapted for home security use?)?”

“If the invention or new idea can be utilized in a different market sector or field, what are these market sectors or fields and how can the invention or new idea be altered, modified, changed or other designed, made, or used differently for the particular field (i.e. for home use of a vehicle security system, can the home system have its own power source and include wired or wireless links connecting the various components of the system?”

It is important to note that the above questions are only examples and can be in any form or format and can include any other questions or types of questions and/or statements or instructions which can be designed in any appropriate manner in order to assist a user to provide thorough and complete information regarding his or her invention or new idea, sufficient enough to prepare an invention disclosure.

At step 210, the user can answer these questions on-line and the central processing computer 10 can receive and process the user's response in a manner so that the responses can be utilized in preparing or generating an invention disclosure.

At step 211, the central processing computer 10 can generate and/or prepare an invention disclosure from the information obtained from the user. The central processing computer 10 can also provide the user with a template so that the user can prepare the invention disclosure from the information.

The central processing computer 10 can also provide the user with a template so that the user can prepare the necessary patent application or provisional patent application forms, transmittal letters, declarations, small entity status forms, assignment forms, fee transmittal sheets, certificates of mailing, etc. for effecting the filing of the invention disclosure.

In the preferred embodiment, the invention disclosure can be generated and prepared by the central processing computer 10 and transmitted the user computer 20 for output by the user at or via the user computer 20. In another preferred embodiment, the user's answers can be stored only at the user computer 20 and can be generated and prepared at the user computer 20 by utilizing any appropriate drafting algorithm provided to or transmitted to the user computer 20 from the central processing computer 10.

Applicant hereby incorporates by reference herein the subject matter and teachings of U.S. Pat. No. 6,049,811 which teaches and discloses a machine for drafting a patent application and process for doing same. The teaching of U.S. Pat. No. 6,049,811 are incorporated by reference herein to provide additional teachings regarding a system or device which can be utilized in preparing or drafting a patent application and/or an invention disclosure.

In a preferred embodiment, the central processing computer can store the information obtained from the user. The information can be stored pursuant to a confidentiality agreement thereby ensuring confidentiality and secrecy of the user's invention and new idea. The central processing computer 10 can also electronically date stamp and time stamp the information so as to provide evidence of idea conception and constructive reduction to practice, thereby providing and maintaining important invention conception information for and on behalf of the user. In another preferred embodiment, the central processing computer 10 will not receive or store any user information or answers, but only provide the above-describe information and/or questions to the user computer 20 for generation of the invention disclosure at the user computer 20.

At step 212, the central processing computer 10 can provide the user with information, instructions, forms, and/or links or hyperlinks, for filing the invention disclosure as a provisional patent application with the appropriate Patent Office, such as, for example, The United States Patent and Trademark Office. The central processing computer 10 can also provide information, instructions, forms, and/or links or hyperlinks, for filing the invention disclosure under a disclosure document or other program.

At step 213, the user can file the invention disclosure as a provisional patent application with the appropriate patent office or official office or agency. The user can file the invention disclosure electronically by linking to the appropriate patent office or official office or agency and filing the invention disclosure and all necessary forms electronically, by downloading the needed forms and physically filing and/or mailing the invention disclosure with the forms to the appropriate patent office or official office or agency, and/or the user can link to, and file the invention disclosure directly with the appropriate patent office or official office or agency by linking to the appropriate patent office or official office or agency computer 70 via the central processing computer 10.

At step 214, the central processing computer 10 can provide the user with information, instruction, and/or links to information for developing a non-provisional patent application, furthering the patenting process, furthering the development process, and/or furthering the commercialization process, for the invention or new idea.

The information provided at step 214 can include information, instructions, links and/or hyperlinks, to informational sources and/or to information source computers 60, information, instructions, links and/or hyperlinks, to investment sources and/or to investors and/or investor computers 50, and/or information, instructions, links and/or hyperlinks to marketing providers and/or marketing provider computers 40. The central processing computer 10 can identify information sources, potential investors, potential buyers, potential licensees, and marketing services providers, by processing stored information regarding these respective sources, entities and parties, in conjunction with information regarding the invention or new idea. The central processing computer 10 can be programmed to identify the appropriate information sources, potential investors, potential buyers, potential licensees, and marketing services providers, which are most suited for assisting the user and/or investing in and/or commercializing the user's invention or new idea.

The central processing computer 10 can store information, contact information and/or any other information, for any number or types of information sources, potential investors, potential buyers, potential licensees, and marketing services providers, so as to provide and serve as a clearinghouse for new inventions and new ideas, and as a clearinghouse for facilitating introductions between the respective users and respective information sources, potential investors, potential buyers, potential licensees, and marketing services providers.

The user can thereafter utilize the information provided by the central processing computer 10 in order to contact and pursue a relationship with a respective information provider(s), potential investor(s), potential buyer(s), potential licensee(s), and/or marketing services provider(s). In this manner, the apparatus 100 can facilitate the protection, development and/or commercialization, of a user's invention or new idea.

At step 215, the central processing computer 10 can provide information and/or links to various service providers, such as for example, attorneys, patent attorneys, patent agents, copyright attorneys, trademark attorneys, intellectual property attorneys, corporate attorneys, patent search firms, marketing firms, product development firms, promotion firms, and any other service providers, marketing providers, etc., who or which can provide assistance to the user, and/or to the respective service provider computer(s) 30 associated therewith.

In this manner, the apparatus 100 can refer the user to a professional service provider who or which can be engaged or retained to respectively perform patent searches, provide a patent validity opinion and/or an infringement opinion, prepare a non-provisional or formal patent application, provide representation in selling or licensing the invention or new idea, form a business entity to exploit the invention or new idea, and/or provide any other legal, marketing and/or business advise, services, and/or expertise to the user. The user can use the information provided to contact and/or engage the services of any of the above-described and/or other service providers. In this manner, the apparatus 100 can serve as a clearinghouse for professional service providers.

At step 216, the central processing computer 10 can store any information described herein as being obtained from the user and/or described herein as being provided to the user in a user file or record for later use or retrieval. Thereafter, the operation of the apparatus 100 will cease at step 217.

If, at step 206, it is determined that the request involves a creation which may involve copyright protection, the operation of the central processing computer 10 will proceed to step 218.

At step 218, the central processing computer 10 can provide questions to the user via the user communication device 20 will serve to illicit information from the user regarding the user's creation. The questions can be designed to obtain information from the user which can facilitate the preparation of a copyright application. Some examples of questions can be as follows:

“What is your creation?”

“What is the nature of the creation, (i.e. copyright category, literary work, novel, poem, product packaging, design logo, etc.)?”

It is important to note that the above questions are only examples and can be in any form or format and can include any other questions or types of questions and/or statements or instructions which can be designed in any appropriate manner in order to assist a user to provide thorough and complete information regarding his or her creation, including information needed to prepare and file a copyright application for the creation.

At step 218, the user can answer these questions on-line and the central processing computer 10 can receive and process the user's response in a manner so that the responses can be utilized in preparing or generating a copyright application. At step 218, the central processing computer 10 can generate and/or prepare a copyright application form for the user.

The central processing computer 10 can also provide the user with a template so that the user can prepare the copyright application. In a preferred embodiment, the central processing computer 10 can store the information obtained from the user. The information can be stored pursuant to a confidentiality agreement thereby ensuring confidentiality and secrecy of the user's creation.

The central processing computer 10 can also electronically date stamp and/or time stamp the information so as to provide evidence of the user's creation. In another preferred embodiment, the central processing computer 10 will not receive or store any user information or answers, but only provide the above-describe information and/or questions to the user computer 20 for generation of the copyright application at the user computer 20.

At step 219, the central processing computer 10 can provide the user with information, instructions, forms, and/or links or hyperlinks, for filing the copyright application, including the creation, with the appropriate Copyright Office, such as, for example, The United States Copyright Office.

At step 220, the user can file the copyright application along with the requisite number of copies of the creation with the appropriate copyright office or official office or agency. The user can file the copyright application electronically by linking to the appropriate copyright office or official office or agency and filing the application electronically, by downloading the needed forms and physically filing and/or mailing the copyright application to the copyright office or official office or agency, and/or the user can link to, and file the copyright application directly with, the appropriate copyright office or official office or agency by linking to the appropriate copyright office or official office or agency computer 70 via the central processing computer 10.

At step 221, the central processing computer 10 can provide the user with information, instructions, and/or links to information, for developing and/or commercializing the creation, for furthering the development process, and/or furthering the commercialization process, for the creation.

The information provided at step 221 can include information, instructions, links and/or hyperlinks, to informational sources and/or to information source computers 60, information, instructions, links and/or hyperlinks to investment sources and/or to investors and/or investor computers 50, and/or information, instructions, links and/or hyperlinks to marketing providers and/or marketing provider computers 40.

The central processing computer 10 can identify information sources, potential investors, potential buyers, potential licensees, publishers, and marketing services providers, by processing stored information regarding these respective sources, entities and parties, in conjunction with information regarding the creation. The central processing computer 10 can be programmed to identify the appropriate information sources, potential investors, potential buyers, potential licensees, publishers, and marketing services providers, which are most suited for assisting the user and/or investing in and/or commercializing the user's creation.

The central processing computer 10 can store information, contact information and/or any other information, for any number or types of information sources, potential investors, potential buyers, potential licensees, publishers, and marketing services providers, so as to provide and serve as a clearinghouse for new creations, and as a clearinghouse for facilitating introductions between the respective users and respective information sources, potential investors, potential buyers, potential licensees, publishers and marketing services providers.

The user can thereafter utilize the information provided by the central processing computer 10 in order to contact and pursue a relationship with a respective information provider(s), potential investor(s), potential buyer(s), potential licensee(s), publisher(s), and/or marketing services provider(s). In this manner, the apparatus 100 can facilitate the protection, development and/or commercialization, of a user's creation.

At step 222, the central processing computer 10 can provide information and/or links to various service providers, such as for example, attorneys, copyright attorneys, trademark attorneys, intellectual property attorneys, patent attorneys, patent agents, corporate attorneys, search firms, marketing firms, product development firms, promotion firms, and any other service providers, marketing providers, etc., who or which can provide assistance to the user, and/or to the respective service provider computer(s) 30 associated therewith.

In this manner, the apparatus 100 can refer the user to a professional service provider who or which can be engaged or retained to respectively perform searches, provide a validity opinion and/or an infringement opinion, prepare additional or copyright applications, provide representation in selling or licensing the creation, form a business entity to exploit the creation, and/or provide any other legal, marketing and/or business advise, services, and/or expertise to the user.

The user can use the information provided to contact and/or engage the services of any of the above-described and/or other service providers. In this manner, the apparatus 100 can serve as a clearinghouse for professional service providers.

At step 223 the central processing computer 10 can store any information described herein as being obtained from the user and/or described herein as being provided to the user in a user file or record for later use or retrieval. Thereafter, the operation of the apparatus 100 will cease at step 224.

In another preferred embodiment, the apparatus 100 can be utilized as an intellectual property clearinghouse for selling and/or licensing intellectual property rights in patents, copyrights, and/or trademarks (hereinafter collectively referred to as “intellectual property”). In this embodiment, the users can classify register their respective intellectual property, inventions, new ideas, creations, works of authorship, and/or trademarks, with the central processing computer 10.

Information regarding the respective intellectual property, inventions, new ideas, creations, works of authorship, and/or trademarks, can include the identity, name, address, phone number, e-mail address and/or other contact information of the respective, inventor, author, owner, assignee of same, a brief description of the respective intellectual property, status of the intellectual property (i.e. issued patent, patent pending, registered trademark, trademark pending, registered copyright, copyright pending, available for licensing, available for exclusive licensing, available for nonexclusive licensing, defined field licenses available, available for purchase, available for cross licensing, etc).

The information can also include terms for investing, investment amounts, investment percentages, terms for purchase, purchase price, terms for licensing, licensing price, defined field license terms and prices, exclusive licensing terms and prices, non-exclusive licensing terms and prices, and any other terms for offering an investment, sale, or license, pertaining the intellectual property. All of the above-described information can be stored in the database of the central processing computer 10.

Information regarding respective individuals, companies, and entities, who or which may desire to invest in an invention, an idea, a creation, or a trademark, or other intellectual property, can also register with the central processing computer 10. Information regarding these registered individuals, companies, and entities, can include the name of identity of same, address, phone number, e-mail address, and/or other contact information, for same, type of individual, company, or entity (i.e. individual investor, manufacturing company, services provider company, intellectual property development and/or commercialization company, intellectual property holding company, the type of products or services provided (i.e. automobile manufacturing company, software company, electronic products company,-pharmaceutical company, publishers, apparel companies, movie studios, television studio, movie or television production companies, etc.), and any other information regarding the individual, company, or entity.

The individual, company or entity, can also request to be notified when certain intellectual property becomes registered with the central processing computer 10. The individual, company, or entity, can also request submissions of new inventions, new ideas, new creations, and trademarks, in certain technology areas or categories, which they may be interested in obtaining and/or licensing. Similarly, users can request to be notified when individuals, companies, or entities, request submissions of new inventions, new ideas, new creations, and trademarks, in certain technology areas or categories, which they may be interested in obtaining and/or licensing.

In this manner, the apparatus 100 can be utilized as an intellectual property clearinghouse for users and individuals, companies, or entities, who or which may want to buy, license, or help develop and commercialize, the inventions, new ideas, and creations, of the users of the apparatus 100.

All of the above-described information can be stored in the database of the central processing computer 10.

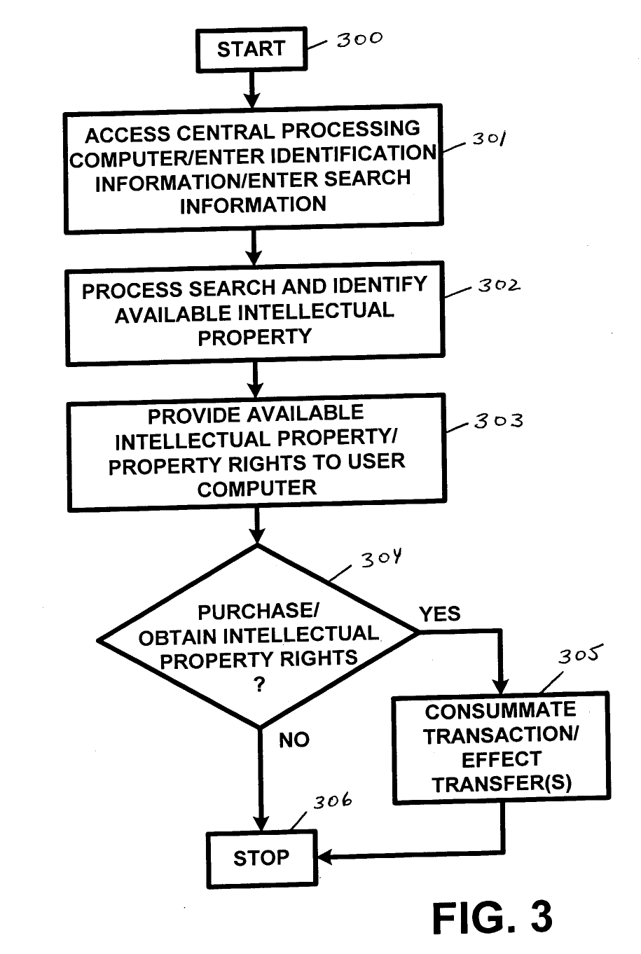

FIG. 3 illustrates another preferred embodiment method for utilizing the apparatus 100 as an intellectual property clearinghouse, in flow diagram form. The embodiment of FIG. 3 is described herein from the vantage point of an individual, company, or entity, in search of intellectual property, inventions, new ideas, or creations, to acquire or license. In another preferred embodiment, the embodiment of FIG. 3 can be utilized by a user in search of information regarding inventions, ideas, or creations, which respective individuals, companies, or entities are desirous of obtaining.

At step 301, the individual, company, or entity (hereinafter “individual”) can access the central processing computer 10 from their respective investor computer 50. At step 301, the individual can enter search information regarding the desired search inventions, new ideas, or creations.

For example, an automobile manufacturer can request information regarding any inventions, new ideas, or creations, in the automobile field. In this manner, the individual can keep abreast of new developments in the field and look into either purchasing or taking a license under any intellectual property corresponding thereto (patents, patent applications, copyrights, etc.).

At step 302, the central processing computer 10 will receive and process the search information, perform the a search of the intellectual property stored in the database of the central processing computer 10 and generate a search report. The search report can provide information regarding the intellectual property, patent number, copyright number, availability of the intellectual property for sale, licenses available, defined field licenses available, cross licenses available, sale terms and/or costs, licensing terms and/or costs for any to the available licenses, and/or any other information for facilitating a sale or licensing of the respective intellectual property.

At step 303 the search report can be transmitted to and viewed by the individual. Although many individuals, companies, or entities, typically will not sign non disclosure agreements regarding new or unsolicited ideas, the apparatus 100 can, pursuant to a prior consent agreement with an individual, company, or entity, document any viewing or reviewing of the information regarding any one or more of the intellectual properties so as to provide a record of the viewing or re-viewing of same so at also protect the rights of the user or owner of the respective intellectual property rights.

At step 303, the individual can review the intellectual properties identified by the search and determine whether or not he, she, or it, desires to any one or more of invest in the intellectual property, so as to purchase a percentage ownership interest in the intellectual property, buy or purchase all rights in the intellectual property, obtain an exclusive license under the intellectual property, obtain a non-exclusive license under the intellectual property, obtain a defined field license under the intellectual property, obtain an exclusive defined field license under the intellectual property, obtain a non-exclusive, purchase an option to buy the intellectual property at a later date, purchase an option to obtain any one or more of the above-described licenses at a later date, and/or invest in the intellectual property in any other manner.

In another preferred embodiment, the central processing computer 10 can, pursuant to a pre-determined set of criteria provided by the individual, can, at pre-determined time intervals, and/or upon the registering of new intellectual property with the central processing computer 10, and/or upon the registering of intellectual property in a certain class or category, automatically perform an intellectual property search, generate a search report, and transmit same to the individual.

At step 303, the individual can determine whether he, she, or it, desires to invest in a certain intellectual property, purchase the rights to the intellectual property, purchase certain rights to the intellectual property (i.e. right to royalties in a certain defined field of use, rights to all causes of action for infringement, right to exclusively license the intellectual property, etc.), and/or whether the individual desires to take a any one or more of the above-described license(s) under the intellectual property.

At step 304, the central processing computer 10 will determine if the individual desires to invest in, purchase, or license, the intellectual property. If, at step 304, it is determined that the individual desires to invest in, purchase, or license, the intellectual property, the operation of the apparatus 100 will proceed to step 305 and the transaction will be consummated between individual and the user or owner of the respective intellectual property. The central processing computer 10 can maintain and administer financial account for and/or on behalf of the respective users, individuals, companies, and entities, who or which utilized the apparatus 100 of the present invention.

The central processing computer 10 can also provide for the electronic transfer of funds as consideration for the herein-described investments, purchases, and/or licenses. Thereafter, at step 305, the central processing computer 10 can notify each of the respective parties of the transaction. At step 305, the central processing computer 10 can also store information regarding any transaction(s) in the database for later use, if desired. Thereafter, the operation of the apparatus will cease at step 306.

If, at step 304, it is determined that the individual is not interested in investing in, purchasing, or licensing, a intellectual property, the operation of the apparatus 100 will cease at step 306.

In another preferred embodiment of FIG. 3, the apparatus 100 of the present invention can be utilized to sell interests or partial interests in a patent application, a patent, a copyright application, a copyrighted work, and/or a trademark. In this embodiment, the respective intellectual property, patent, copyright application, copyrighted work, and/or trademark, can be securitized or have ownership interests represented in shares thereof. These shares of ownership interest can then be sold via the apparatus 100 of the embodiment of FIG. 3.

For example, ownership of a patent application can be represented by X number of ownership shares. Shares of ownership in the patent application can be listed or posted for sale via the apparatus 100. As investors purchase shares of ownership, the proceeds raised from the sale of the ownership sales can be provided to the inventor or other owner of the patent application. The proceeds can also, for example, be utilized in order to allow the inventor or owner to raise money to pay for the services of a patent attorney, a marketer, development costs, and any commercialization costs.

Services providers can also “invest” in the patent application by receiving ownership shares for rendering services related to the protection, development, marketing, and/or commercialization, of the invention. For example, a patent attorney can offer to prosecute a patent application in exchange for an agreed upon ownership interest in a patent application, a marketer or product promoter can agree to market or promote a patent pending product of service for an agreed upon ownership interest in the patent application, etc.

In a similar manner, monetary or “in-kind” investments in any kind or type of intellectual property, patent applications, patents, inventions, new ideas, creations, works of authorship, copyright applications, copyrights, and/or trademarks, can be facilitated by the apparatus 100 of the present invention.

The apparatus of FIG. 3 can be utilized in order to identify and exploit any number or type of possible ownership interests in any of the intellectual properties, patent applications, patents, inventions, new ideas, creations, works of authorship, copyright applications, copyrights, and/or trademarks, described herein.

For example, ownership interests in an intellectual property, in licensing rights for the intellectual property, in the rights to the causes of action which may arise or accrue under the intellectual property, options of purchase the intellectual property, options to license the intellectual property, and/or any other type of right which can be identified and/or created, can be represented by ownership interests which can then be sold, traded, are bartered for, by utilizing the apparatus 100 of the embodiment of FIG. 3. In this manner, the apparatus 100 of the present invention can be utilized to assist inventors, authors, and creators, in finding investors and/or in selling or licensing their respective intellectual property, inventions, new ideas, creations, and/or works of authorship.

The apparatus 100 of FIG. 3 can provides questions or instructions to a user for assisting the user in identifying the types of ownership rights, licensing rights, defined field licensing rights, etc., which can be created, sold, and/or licensed, via the apparatus 100 of the present invention. For example, the apparatus 100 can provide information regarding the sale of licensing of intellectual property rights in certain market sectors, certain regions or geographic areas, and/or in certain defined fields of use.

In the above described manner, the apparatus 100 of the present invention can facilitate the sale or licensing of any of the various types of intellectual property described herein while also facilitating the investment and/or the licensing of intellectual property by certain entities at an early stage of the development thereof. In this manner, for example, an inventor can find investment capital while a business entity can invest in, purchase, or license, intellectual property at an early stage in the development of same and possibly at a lower valuation and/or under much more attractive financial and/or non-financial terms. A company can also, for example, utilize the present invention in order to invest in, purchase, or license, intellectual property which could provide it with an competitive advantage at some later date. It is envisioned that business entities could utilize the present invention in order to acquire intellectual property rights so as to supplement its own research and development activities, to acquire intellectual property assets under favorable conditions and in an efficient and effective manner, and so as to hedge its business and investment activities. In another use, the business entity can obtain licenses under intellectual property simply to protect itself from a future patent infringement action or copyright infringement action under a particular intellectual property.

The apparatus 100 of FIG. 3 can be utilized to in order to sell or license intellectual property rights under any of the types or kinds of intellectual property in a first instance. The apparatus 100 of FIG. 3 can also be utilized in order to sell or license intellectual property rights under any of the types or kinds of intellectual property in subsequent instances thereby creating a trading market for these intellectual property rights.

For example, just as the New York Sock Exchange facilitates the selling and reselling of stocks in a marketplace, the apparatus 100 of the present invention can be utilized to sell and resell ownership interests in any of the respective intellectual properties described herein, in licenses for the respective intellectual properties, and/or in options, futures, and/or derivatives, of any of the herein-described ownership shares, ownership interests, licensing rights, and/or any options, futures, and/or derivative instruments, relating to any of the respective intellectual properties.

In another preferred embodiment, an individual can, at step 303, make an offer or a counter-offer, which can include terms of same, to invest in, purchase, or license, an intellectual property. The central processing computer 10 can receive and store the offer or counter-offer and generate and transmit a message to the user or owner of the intellectual property providing him, her, or it, with information regarding the existence and amount of the offer, counter-offer, or terms of same. The parties can, thereafter, contact each other and enter into negotiations, if desired.

In another preferred embodiment, the user can access the central processing computer 10 and perform a search regarding new ideas, inventions, or creations, which may be desired to be purchased or licensed, by any of the herein-described individuals, companies, or entities. The user can thereafter attempt to develop an invention, new idea, or creation, which satisfies the need of the posting individual, company, or entity.

In another embodiment, the apparatus 100 can be utilized so as to provide a clearinghouse by which users, inventors, authors, and creators, can find or locate service providers who or which can assist them in protecting, developing, marketing, and/or commercializing their respective inventions, new ideas, and creations. In this embodiment, the respective service providers, which can be any of the service providers described herein, can register with the central processing computer 10 and provide information regarding the services which they perform (i.e. prepare patent applications, prepare copyright applications, negotiate licenses, provide litigation services, provide corporate formation services, perform merger and/or acquisition services, perform marketing services, and/or any other services, described herein, and/or which can be related to protecting, developing, marketing, and/or commercializing, inventions, new ideas, and/or creations.

The respective service providers can post information regarding their areas of expertise, services provides, terms or conditions of service, and fees for services and/or representation or engagement.

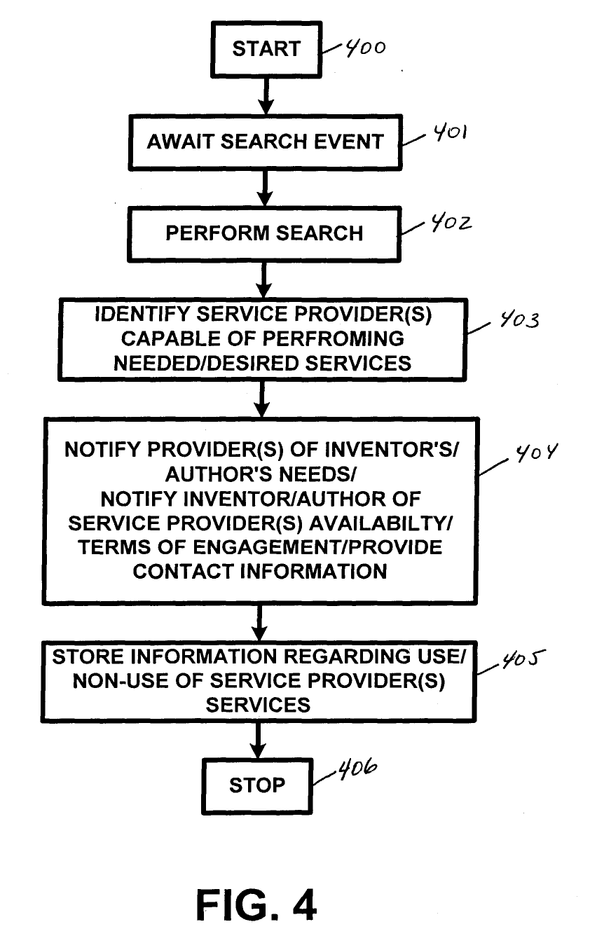

FIG. 4 illustrates still another preferred embodiment method for utilizing the apparatus 100 of the present invention as a clearinghouse for services provided by service providers, in flow diagram form. With reference to FIG. 4, the operation of the apparatus 100 commences at step 400.

At step 401, the central processing computer 10 will await a searching event. The searching event can, for example, be the registration, by a user, of a new idea, invention, or creation, with the central processing computer 10. The user, upon, registering his or her new idea, invention, or creation, can also indicate the amount which he or she desires to pay for obtaining certain services (i.e. $5,000 for patent application preparation, $4,000 for representation in licensing negotiations, etc.).

Upon the occurrence of a searching event, at step 401, the central processing computer 10 will proceed to step 402 and provide a search for service providers who or which may be able to provide services for the user. At step 403, the central processing computer 10 can identify service providers capable of performing needed and/or desired services for the user.

At step 404, the central processing computer 10 can generate a provider notification message and transmit same to the identified service provider(s) in order to provide information to the respective service provider(s) of the user's needs. At step 404, the central processing computer 10 can also generate a user notification message and transmit same to the user in order to provide information to the user of the availability of the service provider(s) to fulfill his or hr needs.

Each of the provider notification messages and the user notification messages can contain the terms for engaging each of the respective parties, the service provider, and/or the user. Each of the provider notification messages and the user notification messages can also contain contact information for each of the respective parties, the service provider, and/or the user. Thereafter, the user may engage a service provider to have a service performed on his or her behalf.

The user can also provide information to the central processing computer 10 regarding his or her experience with the service provider which can also include information regarding the level of satisfaction or dissatisfaction with the service provider or the services performed by the service provider. In a similar manner, the service provider can also provide information to the central processing computer 10 regarding his or her experience with the user which can also include information regarding the level of satisfaction or dissatisfaction with the user.

At step 405, the central processing computer 10 can store information regarding the engagement or non-engagement of a service provider(s). Thereafter, the operation of the central processing computer 10 will cease at step 406.

In another preferred embodiment, the central processing computer 10 can be utilized to securitize an ownership interest in any of the intellectual properties described herein.

The securitizable intellectual properties can include an invention, a new idea, a patent application, and issued patent, foreign patent rights, a copyright application, a new creation, a work of authorship, a registered copyright, a trademark, a common law trademark, a trademark application, a registered trademark, a license under any of the above intellectual properties, an exclusive license under any of the above intellectual properties, a non-exclusive license under any of the above intellectual properties, a defined field license under any of the above intellectual properties, and an option to any one or more of to purchase, to purchase an ownership interest in, and to license any of the above intellectual properties.

In this embodiment, the central processing computer 10 can include a database for storing at least one of information regarding an intellectual property, a property right in an intellectual property, a licensing right under an intellectual property, an option to purchase a right in an intellectual property, and an option to license an intellectual property.

The central processing computer 10 can also include a processor for securitizing the at least one of a property right in an intellectual property, a licensing right under an intellectual property, an option to purchase a right in an intellectual property, and an option to license an intellectual property, into ownership shares, wherein the processor determines a price of a share of the ownership shares, and further wherein the ownership shares are freely tradable in a marketplace, wherein the processor generates a message containing information regarding the ownership shares.

The central processing computer 10 can also include at least one of an output device, a display device, and a transmitter, for providing information regarding the ownership shares.

The central processing computer 10 can process a transaction involving a purchase or a sale of the ownership shares. The central processing computer 10 can also administer a trading account for any number of investors who desire to invest in the ownership shares.

The apparatus 100 and/or the central processing computer 10 can also be utilized so as to facilitate any one or more of capital raising for an intellectual property, capital raising for a development of an intellectual property, investment in an intellectual property, and a secondary market for trading ownership shares in an intellectual property.

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus for providing information for protecting and/or commercializing an invention or new idea, comprising:
a receiver for receiving a request for information regarding protecting an invention or new idea, wherein the request is received from a user communication device;
a processor for processing the request, wherein the processor generates a message containing at least one of a question and an instruction for obtaining information regarding the invention or new idea; and
a transmitter for transmitting the message to the user device,
wherein the receiver receives a user response to the at least one of question and an a instruction, and further wherein the processor generates an invention disclosure containing information regarding the invention or new idea.

2. The apparatus of claim 1, wherein the processor at least one of times stamps and date stamps the invention disclosure.

3. The apparatus of claim 1, wherein the processor transmits at least one of a provisional application for patent cover sheet form, a patent application transmittal form, a declaration, a small entity status form, and form containing a mailing certificate, to the user communication device.

4. The apparatus of claim 1, wherein the at least one of a question and an instruction contains information for obtaining invention or new idea information concerning at least one of a nature of the invention or new idea, an advantage of the invention or new idea, the component parts or component steps of the invention or new idea, information for using the invention or new idea, a market sector for the invention or new idea, and an additional market sector for the invention or new idea.

5. The apparatus of claim 3, wherein the user can fill out a formal filing form at the user communication device.

6. The apparatus of claim 1, wherein the processor provides a link to an official filing office for filing the invention disclosure, and further wherein the user files the invention disclosure as at least one of a provisional patent application and a disclosure document at least one of directly with the official filing office and via the apparatus.

7. The apparatus of claim 1, wherein the processor generates information regarding at least one of invention or new product development information, invention or new product marketing information, commercialization information, and information regarding a service provider for providing at least one of legal services, patent application drafting services, consulting services, business information services, marketing services, market or marketing research services, and new product or service development services.

8. The apparatus of claim 1, wherein the invention or new idea is protectable by at least one of a provisional patent application filing, a patent application filing, a disclosure document filing, a patent pending, and an issued patent.

9. An apparatus for providing information for protecting and/or commercializing a new creation or work of authorship, comprising:
a receiver for receiving a request for information regarding protecting a new creation or work of authorship, wherein the request is received from a user communication device;
a processor for processing the request, wherein the processor generates a message containing at least one of a question and an instruction for obtaining information regarding the new creation or work of authorship; and
a transmitter for transmitting the message to the user device,
wherein the receiver receives a user response to the at least one of question and an a instruction, and further wherein the processor generates a form containing information regarding the new creation or work of authorship.

10. The apparatus of claim 9, wherein the processor at least one of times stamps and date stamps the form.

11. The apparatus of claim 9, wherein the processor transmits a copyright application form to the user communication device.

12. The apparatus of claim 9, wherein the at least one of a question and an instruction contains information for obtaining information concerning at least one of a nature of the new creation or work of authorship, an advantage of the new creation or work of authorship, the component parts or component steps of the new creation or work of authorship, information for using the new creation or work of authorship, a market sector for the new creation or work of authorship, and an additional market sector for new creation or work of authorship.

13. The apparatus of claim 11, wherein the user can fill out a formal filing form at the user communication device.

14. The apparatus of claim 9, wherein the processor provides a link to an official filing office for filing the new creation or work of authorship, and further wherein the user files the new creation or work of authorship as a copyright application at least one of directly with the official filing office and via the apparatus.

15. The apparatus of claim 9, wherein the processor generates information regarding at least one of new creation or work of authorship development information, new creation or work of authorship product marketing information, commercialization information, and information regarding a service provider for providing at least one of legal services, patent application drafting services, consulting services, business information services, marketing services, market or marketing research services, and/or new product or service development services.

16. The apparatus of claim 9, wherein the new creation or work of authorship is protectable by a copyright application and a registered copyright.

17. An apparatus for providing information regarding intellectual property, comprising:
a processor for processing a request to receive information regarding an intellectual property right available for at least one of sale, acquisition, and licensing, wherein the processor generates a message containing information regarding at least one intellectual property right for at least one of sale, acquisition, and licensing; and
a transmitter for transmitting the message to a communication device associated with a requesting party.

18. The apparatus of claim 17, wherein the intellectual property right is a full ownership interest in the intellectual property, a partial ownership interest in the intellectual property, a share of an ownership interest in the intellectual property, a license under the intellectual property, an exclusive license under the intellectual property, a non-exclusive license under the intellectual property, a defined field exclusive license under the intellectual property, a defined field non-exclusive license under the intellectual property, a right to a cause of action arising under the intellectual property, an option to purchase the intellectual property, an option to purchase a partial ownership interest in the intellectual property, an option to purchase a share of ownership interest in the intellectual property, and an option to obtain at least one of a license, an exclusive license, a non-exclusive license, and a defined field license, under the intellectual property.

19. The apparatus of claim 17, further comprising:
a receiver for receiving a request to receive information regarding the intellectual property right available for at least one of sale, acquisition, and licensing, wherein the receiver receives a request from the party to at least one of purchase at least one of the intellectual property, a partial interest in the intellectual property, a share in the intellectual property, an option to purchase at least one of the intellectual property, a partial interest in the intellectual property, and a share of the intellectual property, an option to obtain a license under the intellectual property, and to license the intellectual property at least one of exclusively, non-exclusively, and in at least one defined field.

20. The apparatus of claim 17, wherein the apparatus is programmed to automatically generate the message upon the occurrence of a pre-defined event, wherein the pre-defined event is the listing or posting of an intellectual property at least one of available for sale, acquisition, and licensing.

21. An apparatus for providing information regarding a protection and/or a commercialization of intellectual property, comprising:
a processor for processing information regarding a need for services regarding an intellectual property, wherein the processor generates a message containing information regarding at least one service provider capable of performing a needed service; and
a transmitter for transmitting the message to a user communication device.

22. An apparatus for providing information regarding intellectual property, comprising:
a database for storing at least one of information regarding an intellectual property, a property right in an intellectual property, a licensing right under an intellectual property, an option to purchase a right in an intellectual property, and an option to license an intellectual property; and
a processor for securitizing the at least one of a property right in an intellectual property, a licensing right under an intellectual property, an option to purchase a right in an intellectual property, and an option to license an intellectual property, into ownership shares, wherein the processor determines a price of a share of the ownership shares, and further wherein the ownership shares are freely tradable in a marketplace, wherein the processor generates a message containing information regarding the ownership shares; and
at least one of an output device, a display device, and a transmitter, for providing information regarding the ownership shares.
